(19) United States
(12) Patent Application Publication
(10) Pub. No.: US 2025/0318472 A1
(43) Pub. Date: Oct. 16, 2025

(54) SUGARCANE HARVESTER WITH RESIDUE CAPTURE SYSTEM

(71) Applicant: DEERE & COMPANY, MOLINE, IL (US)

(72) Inventors: Felipe Nascimento, Catalão (BR); Jae-Jae Young, Thibodaux, LA (US); DUSK S. MIXON, Saint Amant, LA (US); SURFRAJ FATTEPUR, PUNE (IN); Mahadev Subhash Pansare, PUNE (IN); RUSHIKESH DAKHORE, Risod (IN); Leonardo A. Rosa, Catalão (BR)

(21) Appl. No.: 19/044,695

(22) Filed: Feb. 4, 2025

Related U.S. Application Data
(60) Provisional application No. 63/632,685, filed on Apr. 11, 2024.

(51) Int. Cl. A01F 12/48; A01D 61/00

(52) U.S. Cl. CPC A01F 12/48; A01D 61/00

(57) ABSTRACT

A sugarcane harvester includes an extractor operable to induce a flow of air through a stream of sugarcane billets for separating leaf material from the billets. The extractor includes a hood defining an exhaust outlet for discharging the leaf material from the extractor in a desired direction. An elevator includes a conveyor operable to receive the billets and lift the billets to the distal discharge end of the elevator. A residue capture system is attached to the elevator structure and is configured for receiving the leaf material discharged from the extractor and separating the leaf material from the flow of air, whereby the leaf material settles onto the conveyor of the elevator with the billets.

### CROSS-REFERENCE TO RELATED APPLICATIONS

This application claims the benefit of U.S. Provisional Patent Application Ser. No. 63/632,685, filed on Apr. 11, 2024, the disclosure of which is hereby incorporated by reference.

### TECHNICAL FIELD

The disclosure generally relates to a sugarcane harvester.

### BACKGROUND

Sugarcane harvesters often have a basecutter assembly positioned to sever sugarcane stalks adjacent a ground surface, and convey the sugarcane stalks to a chopper. The chopper cuts the sugarcane stalks into billets and ejects or discharges the billets into the air and towards an elevator. An extractor is positioned between the chopper and the elevator to induce a flow of air through the billets for removing unwanted leaf material and other debris from the flow of billets as the billets move through the air between the chopper and the elevator. A hood is disposed on the extractor, and is moveable to control a direction in which the leaf material is discharged from the extractor.

Once the billets are ejected from the chopper, gravity acts on the billets causing the billets to fall vertically downward as the extractor removes the leaf material. The elevator includes an elevator structure that is attached to a main frame of the sugarcane harvester, and extends upward toward a distal discharge end of the elevator. The elevator structure is generally moveable relative to a main frame of the sugarcane harvester to position the distal discharge end adjacent a wagon. The elevator includes a conveyor that is moveably supported by the elevator structure, and which is operable to lift the sugarcane billets to the distal discharge end of the elevator, whereby the billets are discharged into the wagon for transport to a mill.

### SUMMARY

A sugarcane harvester is provided. The sugarcane harvester includes a main frame. A basecutter assembly includes a cutting disk configured for severing stalks of sugarcane adjacent a ground surface. A chopper having a drum is configured for cutting the stalks of sugarcane into billets. An extractor having a fan assembly is configured to induce a flow of air through the billets for separating leaf material from the billets. The extractor includes a hood moveable relative to the main frame. The hood includes an exhaust outlet that is selectively positionable relative to the main frame for discharging the leaf material from the extractor in a desired direction. An elevator includes an elevator structure that is attached to the main frame. The elevator structure extends to a distal discharge end. The elevator includes a conveyor moveably supported on the elevator structure. The conveyor is operable to receive the billets from the chopper and lift the billets to the distal discharge end of the elevator structure. A residue capture system is attached to the elevator structure. The residue capture system is configured for receiving the leaf material discharged from the extractor and separating the leaf material from the flow of air, whereby the leaf material settles onto the conveyor of the elevator.

Accordingly, if an end user desires to capture the leaf material with the sugarcane billets, for example for use as a biomass product, the hood may be positioned to align the exhaust outlet of the hood with the inlet of the collection chamber of the residue capture system, thereby directing the extracted leaf material onto the conveyor, whereby the sugarcane billets and the leaf material may be loaded into a container. If the extractor is equipped with a residue shredder, the leaf material may be shredded as it passes through the extractor, thereby reducing a volumetric size of the leaf material when loaded into the container when compared to non-shredded leaf material. If the end user does not desire to capture the leaf material, then the hood of the extractor may be positioned such that the exhaust outlet of the hood is not aligned with the inlet of the collection chamber, thereby discharging the extracted leaf material onto the ground surface.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic side view of a sugarcane harvester.

FIG. 2A is a schematic perspective view of the sugarcane harvester showing a hood of an extractor aligned with an inlet of a residue capture system to capture leaf material from the extractor.

FIG. 2B is a schematic perspective view of the sugarcane harvester showing the hood not aligned with the residue capture system to discharge leaf material onto a ground surface.

FIG. 3 is a schematic exploded perspective view of the residue capture system.

FIGS. 4A-4C are schematic side views of the residue capture system showing different implementations of an upper vent structure.

FIGS. 5A-5F are schematic side views of the residue capture system showing different combinations of panel segments of a vent cover system.

FIG. 5G is a schematic perspective view of the residue capture system showing a panel segment of the vent cover system with a baffle.

FIG. 6 is a schematic side view of an alternative embodiment of the sugarcane harvester, showing a secondary extractor atop an elevator.

FIG. 7 is a schematic perspective view of the secondary extractor.

FIG. 8 is a schematic partial perspective view of the sugarcane harvester showing an alternative implementation of a seal of the residue capture system.

FIG. 9 is a schematic partial perspective view of the sugarcane harvester showing an optional flexible shroud of the residue capture system.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

The terms “forward”, “rearward”, “left”, and “right”, when used in connection with a moveable implement and/or components thereof are usually determined with reference to the direction of travel during operation, but should not be construed as limiting. The terms “longitudinal” and “transverse” are usually determined with reference to the fore-and-aft direction of the implement relative to the direction of travel during operation, and should also not be construed as limiting.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

As used herein, “e.g.” is utilized to non-exhaustively list examples, and carries the same meaning as alternative illustrative phrases such as “including,” “including, but not limited to,” and “including without limitation.” As used herein, unless otherwise limited or modified, lists with elements that are separated by conjunctive terms (e.g., “and”) and that are also preceded by the phrase “one or more of,” “at least one of,” “at least,” or a like phrase, indicate configurations or arrangements that potentially include individual elements of the list, or any combination thereof. For example, “at least one of A, B, and C” and “one or more of A, B, and C” each indicate the possibility of only A, only B, only C, or any combination of two or more of A, B, and C (A and B; A and C; B and C; or A, B, and C). As used herein, the singular forms “a”, “an” and “the” are intended to include the plural forms as well, unless the context clearly indicates otherwise. Further, “comprises,” “includes,” and like phrases are intended to specify the presence of stated features, steps, operations, elements, and/or components, but do not preclude the presence or addition of one or more other features, steps, operations, elements, components, and/or groups thereof.

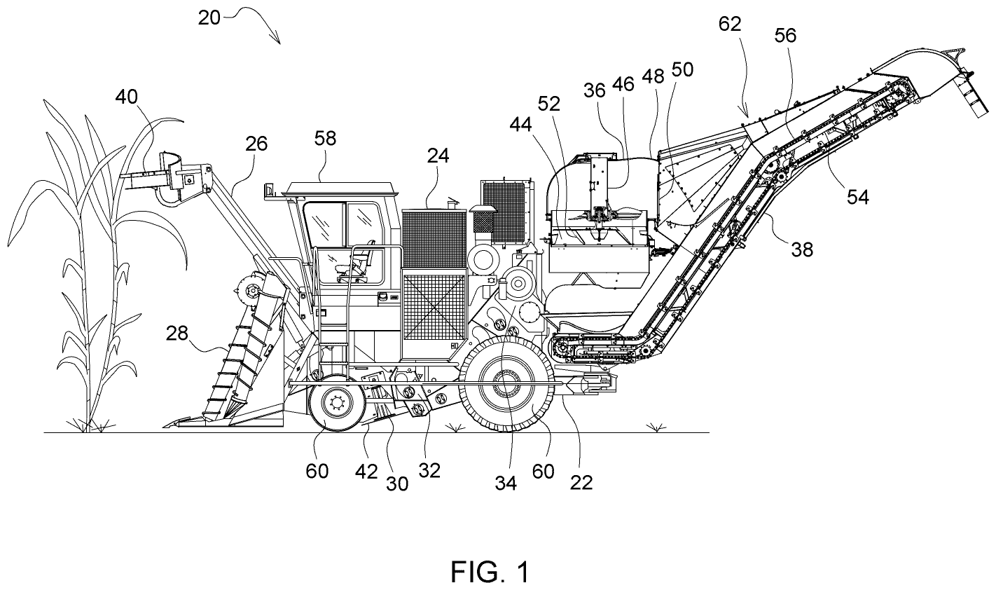

Referring to the Figures, wherein like numerals indicate like parts throughout the several views, a sugarcane harvester is generally shown at 20. Referring to FIG. 1, the sugarcane harvester 20 includes a main frame 22. The main frame 22 supports various cutting, routing and processing devices. An engine 24 may supply power for driving the sugarcane harvester 20 and for powering various driven components of the sugarcane harvester 20. In certain embodiments, the engine 24 may directly power a main hydraulic pump (not shown). Various driven components of the sugarcane harvester 20 may be powered by hydraulic motors receiving hydraulic power from the main hydraulic pump via one or more hydraulic loops (not shown).

Referring to FIG. 1, among other components and features, some of which are not described herein, the sugarcane harvester 20 may include a topper assembly 26, a left and a right crop divider scroll 28 (the left crop divider scroll 28 is not shown), an upper knockdown roller and a lower knockdown roller (the upper and lower knockdown rollers are not shown), a basecutter assembly 30, a feed section 32, a chopping section or chopper 34, an extractor 36, and an elevator 38.

The topper assembly 26 is mounted to the main frame 22. The topper assembly 26 includes a cantilevered arm structure attached to the main frame 22. The cantilevered arm extends from the main frame 22 to a distal end thereof, in a generally forward direction relative to a direction of travel during harvest operations, and a generally upward direction relative to a ground surface. The topper assembly 26 includes a top cutter 40 supported by the cantilevered arm proximate the distal end of the cantilevered arm. The top cutter 40 is positioned for severing an upper leaf portion of a sugarcane plant from a central stalk portion of the sugarcane plant. The top cutter 40 may include a blade or other cutting device and/or system configured for cutting the sugarcane plant. The particular components, structure and operation of the top cutter 40 are understood by those skilled in the art, and are therefore not described in greater detail herein.

The left and right crop divider scrolls 28 are adapted to lift the sugarcane plants for feeding into a throat of the sugarcane harvester 20. The upper and lower knockdown rollers are adapted to lean standing sugarcane plants in the forward direction relative to the direction of travel of the sugarcane harvester 20 during operation.

The basecutter assembly 30 is mounted to the main frame 22 adjacent the ground surface. The basecutter assembly 30 includes a cutting disk 42 or other cutting device that is configured for severing the sugarcane plants adjacent the ground surface. The basecutter assembly 30 is operable to sever a central stalk portion of the sugarcane plant from a bottom root portion of the sugarcane plant. The basecutter assembly 30 is adapted to sever the sugarcane plants knocked down or leaned over in the forward direction by the upper and lower knockdown rollers. Additionally, the basecutter assembly 30 is operable to move and/or feed the central stalk portion of the sugarcane plant to the feed section 32.

The feed section 32 is adapted to receive a mat of severed sugarcane crop material from the basecutter assembly 30, and to move the mat of crop material rearwardly for further processing. The feed section 32 may include, for example, successive pairs of upper and lower feed rollers rotatably supported by the main frame 22. At least one pair of the upper and lower feed rollers may be powered to transport the mat of the cut sugarcane crop material to the chopper 34. The chopper 34 is adapted to receive the mat from the feed section 32 and to cut the sugarcane plant into billets. The chopper 34 may include, for example, a drum configured for cutting the stalks of sugarcane into billets.

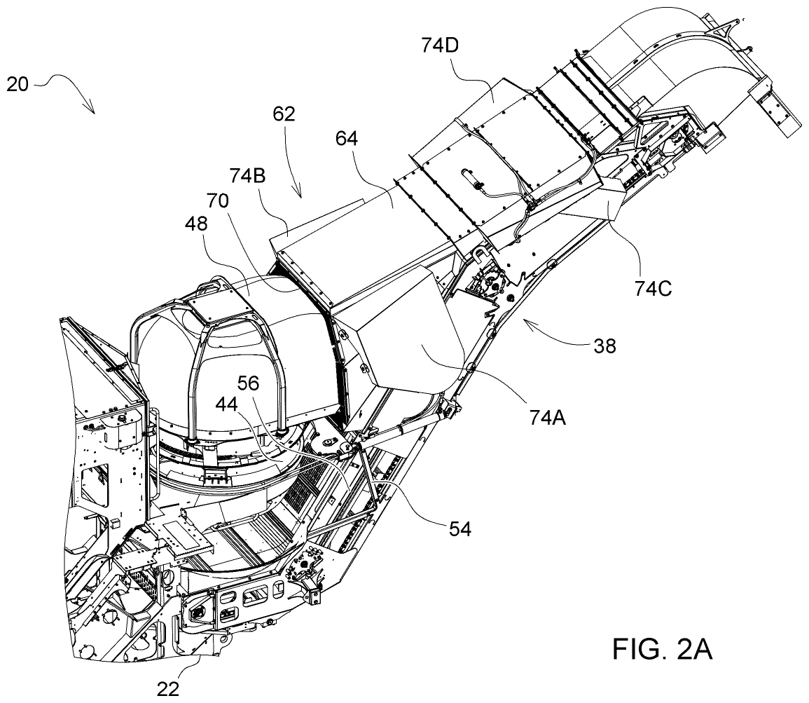

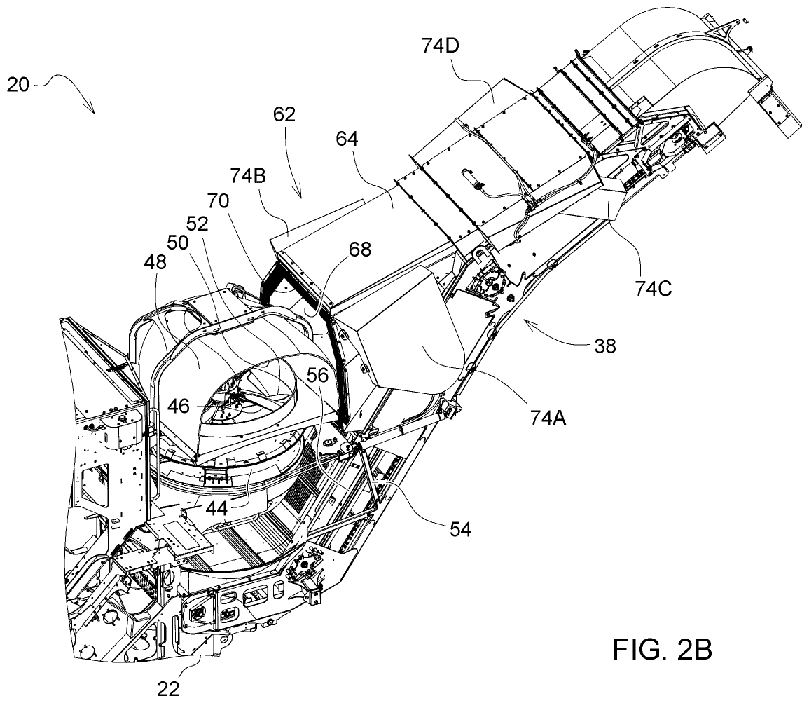

The extractor 36 is positioned downstream from the chopper 34 and is adapted to separate debris, including, for example, crop residue (e.g., leafy material), from the billets and remove the debris from the sugarcane harvester 20. Referring to FIG. 1, the extractor 36 includes a fan housing 44 defining an interior passage extending along a central axis. The extractor 36 further includes a fan assembly 46 disposed and/or positioned within the interior passage of the fan housing 44. The fan assembly 46 includes one or more fan blades (e.g., four fan blades) mounted for rotation about the central axis in a direction of rotation of the fan blades. Rotation of the fan blades about the central axis induces a flow of air through the interior passage of the fan housing 44 of the extractor 36. The flow of air through the fan housing 44 extracts the leaf material from the flow of billets produced by the chopper 34. A hood 48 is attached to the fan housing 44 of the extractor 36. The hood 48 defines an exhaust outlet 50 through which the leaf material is discharged from the extractor 36. Referring to FIGS. 2A-2B, the hood 48 may be moveable relative to the main frame 22 to position the exhaust outlet 50 relative to the main frame 22 and the elevator 38. A rotator may be coupled to the hood 48 for rotating the hood 48 relative to the main frame 22 to direct discharge of the extracted leaf material from the exhaust outlet 50 in a desired direction.

Referring to FIG. 1, in some implementations, the extractor 36 may include a leaf shredder 52 that is configured for shredding the leaf material and other debris passing through the extractor 36. The leaf shredder 52 may include one or more shredding knives mounted for rotation about the axis of rotation of the fan assembly 46 to shred leaf material prior to its ejection from the extractor 36. The leaf shredder 52 reduces the size of the leaf material passing through the extractor 36, which reduces storage volume when the leaf material is collected with the billets via a residue capture system 62 described in greater detail below. Shredding the leaf material passing through the extractor 36 enables a greater mass of residue to be collected in a container with the sugarcane billets when compared to un-shredded leaf material. An example implementation of the leaf shredder 52 is described in US Published Patent Application 2023/0120208, Ser. No. 17/451,390, which is assigned to the Applicant of this application, the disclosure of which is incorporated by reference herein.

The billets are airborne when discharged from the chopper 34 facilitating separation of the leaf material from the billets by the flow of air induced by the fan assembly 46. Referring to FIG. 1, the elevator 38 is positioned at the rear of the sugarcane harvester 20 to receive the cleaned flow of billets from the chopper 34, and is adapted to convey the billets to an elevated position where the billets are discharged into a container or transport vehicle to be hauled away. The elevator 38 is configured for lifting the sugarcane billets from a lower receiving elevation to an upper discharge elevation. As described above, once ejected from the chopper 34, gravity acts on the billets causing the billets to fall vertically downward as the extractor 36 removes the leaf material therefrom.

The elevator 38 includes an elevator structure 54 that is attached to the main frame 22. The elevator structure 54 is attached to the main frame 22 proximate a lower end of the elevator structure 54, and extends upward and outward to a distal discharge end. The elevator 38 includes a conveyor 56 that is moveably supported on the elevator structure 54. The conveyor 56 may include, for example, but is not limited to an end endless belt or other similar structure. The conveyor 56 may include flighting or other similar structure to engage the billets and move the billets vertically upward. The conveyor 56 is operable to receive the billets from the chopper 34 and lift the billets to the distal discharge end of the elevator structure 54, whereby the billets are discharged from the elevator 38 into the transport vehicle.

Referring to FIG. 1, the sugarcane harvester 20 may include an operator station 58 and traction elements 60. The various user input and control devices, data output devices, etc., may be located within the operator station 58. A human operator may operate the sugarcane harvester 20 from the operator station 58. In certain embodiments, the main frame 22 may be supported by a transport frame such as track frame supporting the traction elements 60. The traction elements 60 are positioned on the left and right sides of the sugarcane harvester 20 for propelling the sugarcane harvester 20 through a field and along the ground surface. Each traction element may include, but is not limited to, a track unit or a ground-engaging wheel.

Some end users may wish to collect the leaf residue with the sugarcane billets for use as a biomass fuel. However, un-shredded leaf material is bulky and requires a significant volume for storage in the transport vehicle. Accordingly, by shredding the leaf material with the leaf shredder 52 disposed in the extractor 36, the storage volume of the leaf material may be greatly reduced. This process requires the separation of the leaf material via the extractor 36, shredding the leaf material with the leaf shredder 52 disposed within the extractor 36, and then combining the shredded leaf material with the sugarcane billets for loading onto the transport vehicle. As noted above, the sugarcane harvester 20 may include the residue capture system 62 for combining the leaf residue removed by the extractor 36 with the sugarcane billets on the conveyor 56 of the elevator 38.

Referring to FIG. 2A, the residue capture system 62 may be attached to the elevator structure 54 and is configured for receiving the leaf material discharged from the extractor 36. It should be appreciated that the fan assembly 46 of the extractor 36 induces the flow of air through the fan housing 44 to move the leaf material therethrough. As such, the leaf material is suspended within the flow of air moving through and discharged from the exhaust outlet 50 of the hood 48 of the extractor 36. The residue capture system 62 separates the leaf material from the flow of air induced by the fan assembly 46 of the extractor 36, whereby the leaf material may settle onto the conveyor 56 of the elevator 38 with the sugarcane billets and be lifted to the discharge end of the elevator 38.

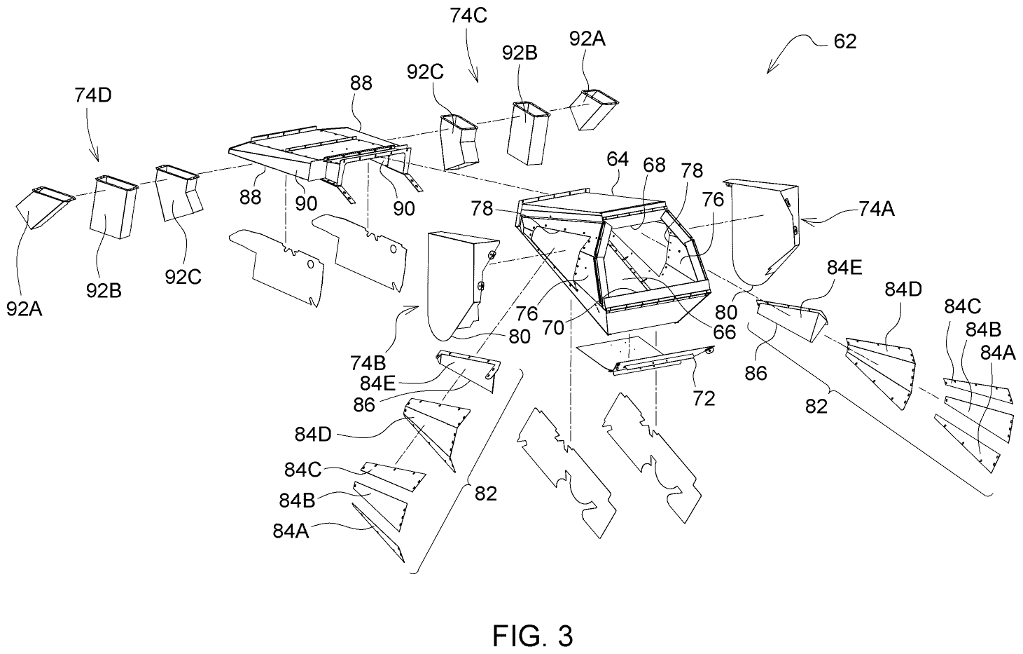

Referring to FIG. 3, the residue capture system 62 includes a collection housing 64 that may be attached to the elevator structure 54. The collection housing 64 defines a collection chamber 66 having an inlet 68. The inlet 68 of the collection chamber 66 is arranged for receiving the leaf material from the exhaust outlet 50 of the hood 48 when the hood 48 is positioned to align the exhaust outlet 50 of the hood 48 with the inlet 68 of the collection chamber 66, such as shown in FIG. 2A. It should be appreciated that if the end user desired to combine the leaf material from the extractor 36 with the sugarcane billets, via the residue capture system 62, then an operator may rotate the hood 48 until the exhaust outlet 50 of the hood 48 is aligned with the inlet 68 of the collection chamber 66. However, if the end user does not wish to combine the leaf material from the extractor 36 with the sugarcane billets and instead discharge the leaf material onto the ground surface, then the operator may position the exhaust outlet 50 of the hood 48 away from the inlet 68 of the collection chamber 66, whereby the discharged leaf material will not enter the inlet 68 of the collection chamber 66, such as shown in FIG. 2B.

Referring to FIG. 2A, the inlet 68 of the collection housing 64 of the residue capture system 62 includes a shape that may be configured to substantially mate with a shape of the exhaust outlet 50 of the hood 48. Additionally, the shape and size of the collection housing 64 and the shape and size of the hood 48 may be configured to enable the extractor 36 and hood 48 to rotate relative to the elevator 38 and the residue capture system 62, between an aligned position in which the exhaust outlet 50 of the hood 48 is aligned with the inlet 68 of the collection housing 64, and a non-aligned position in which the exhaust outlet 50 of the hood 48 is not aligned with the inlet 68 of the collection housing 64.

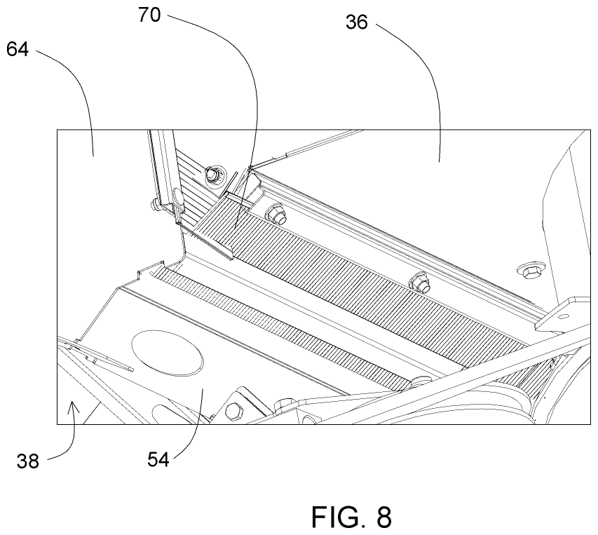

Referring to FIG. 3, the residue capture system 62 may include a seal 70 disposed between the collection housing 64 of the residue capture system 62 and the hood 48 for sealing therebetween. In one implementation, such as shown in FIG. 3, the seal 70 is attached to the collection housing 64 of the residue capture system 62. However, in other implementations, the seal may be attached to the extractor 36, such as shown in FIG. 8. The seal 70 may be configured to limit and/or prevent leaf material from passing through the joint between the hood 48 and the collection housing 64. The seal 70 may include, for example, a flexible material configured to conform to the shape of the exhaust outlet 50 of the hood 48. The seal 70 may be configured to expand and/or move, for example, by incorporating bellows or other similar structure.

Referring to FIG. 3, the collection housing 64 of the residue capture system 62 may optionally include a deflector 72 disposed within the collection chamber 66. The deflector 72 may be shaped for directing movement of the leaf material through the collection chamber 66. For example, the deflector 72 may be shaped to form a ramp to direct the movement of the leaf material entering through the inlet 68 of the collection chamber 66 to substantially align with the orientation of the conveyor 56 of the elevator 38. By so doing, the deflector 72 may reduce the impact angle at which the leaf material engages the conveyor 56 of the extractor 36.

Referring to FIGS. 2A-2B and 3, The residue capture system 62 may optionally further include at least one vent structure 74A-74D coupled to the collection housing 64. The vent structure 74A-74D is configured to vent air pressure from within the collection chamber 66, while maintaining the leaf material within the collection chamber 66 and on the conveyor 56 of the elevator 38. Additionally, the vent structure 74A-74D may optionally be configured to discharge leaf material from the collection housing 64 to thereby control an amount of leaf material collected with the sugarcane billets. As such, if the operator wishes to capture only a portion of the leaf material discharged from the extractor 36, the vent structure 74A-74D may be configured to discharge a portion of the leaf material out of the collection housing 64 so that only the desired portion of the extracted leaf material is combined with the sugarcane billets and loaded into the wagon for transport to the mill.

As described above, the leaf material from the extractor 36 is introduced into the collection chamber 66 of the residue capture system 62 via the flow of air induced by the fan assembly 46. As such, introducing this flow of air and the entrained leaf material into the collection chamber 66 pressurizes the collection chamber 66. The vent structure 74A-74D is configured to dissipate the air pressure within the collection chamber 66, thereby allowing the leaf material to settle onto the conveyor 56 of the elevator 38.

The example implementation of the vent structure 74A-74D shown in the Figures includes a left lower vent structure 74A, a right lower vent structure 74B, a left upper vent structure 74C, and a right upper vent structure 74D. However, it should be appreciated that the residue capture system 62 may be configured differently to include a different number of vent structures, and/or with different locations of the vent structures then the example implementation described herein. The left lower vent structure 74A and the right lower vent structure 74B are each disposed proximate the inlet 68 of the collection chamber 66 on opposing lateral sides of the elevator structure 54. The left lower vent structure 74A and the right lower vent structure 74B may be mirror images of each other. As such, only a singular lower vent structure 74A, 74B is described below. It should be appreciated that the description of the lower vent structure 74A, 74B below applies to both the left lower vent structure 74A and the right lower vent structure 74B. The left upper vent structure 74C and the right upper vent structure 74D are each disposed proximate an outlet of the collection housing 64 on opposing lateral sides of the elevator structure 54. The left upper vent structure 74C and the right upper vent structure 74D may be mirror images of each other. As such, only a singular upper vent structure 74C, 74D is described below. It should be appreciated that the description of the upper vent structure 74C, 74D below applies to both the left upper vent structure 74C and the right upper vent structure 74D.

Referring to FIG. 3, the collection housing 64 of the residue capture system 62 includes a side wall 76 extending vertically along a lateral side of the conveyor 56. The side wall 76 defines a lower vent port 78 positioned above the conveyor 56. The lower vent port 78 defines an opening 80 through the side wall 76 of the collection housing 64, between an interior of the collection chamber 66 and an exterior of the collection chamber 66. It should be appreciated that each respective lower vent structure 74A, 74B will include an associated and respective lower vent port 78.

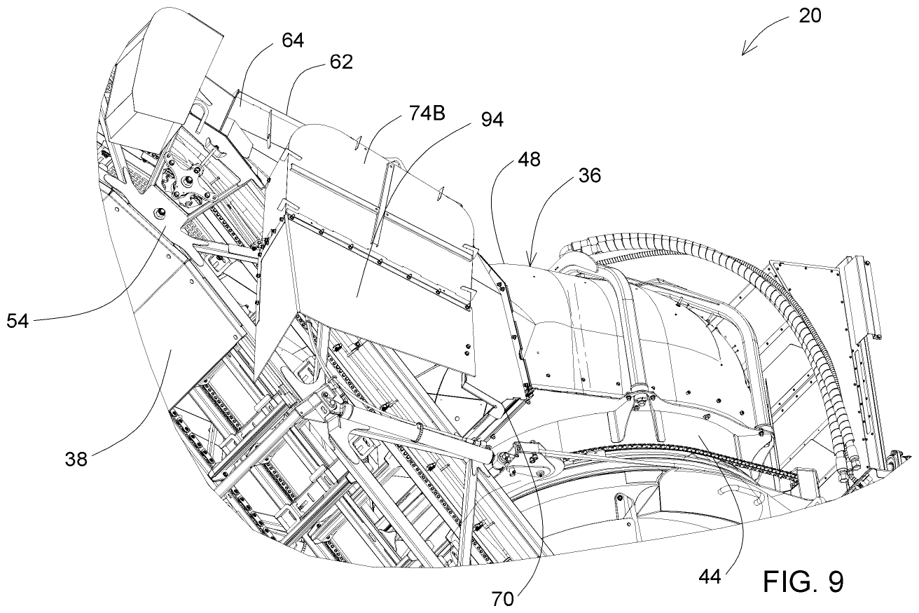

The lower vent structure 74A, 74B is attached to the collection housing 64 adjacent an exterior of the collection housing 64 to cover the lower vent port 78. The lower vent structure 74A, 74B cooperates with the side wall 76 of the collection housing 64 to define an opening 80. The opening 80 of the lower vent structure 74A, 74B may be, but is not required to be, positioned below the conveyor 56. Optionally, a flexible shroud 94, such as shown in FIG. 9, may be attached to a lower bottom edge of the lower vent structure 74A, 74B, generally about the opening 80. The flexible shroud 94 may include, for example, a flexible material, such as a rubber or rubber-like material, that is configured to conform to the shape of the opening 80.

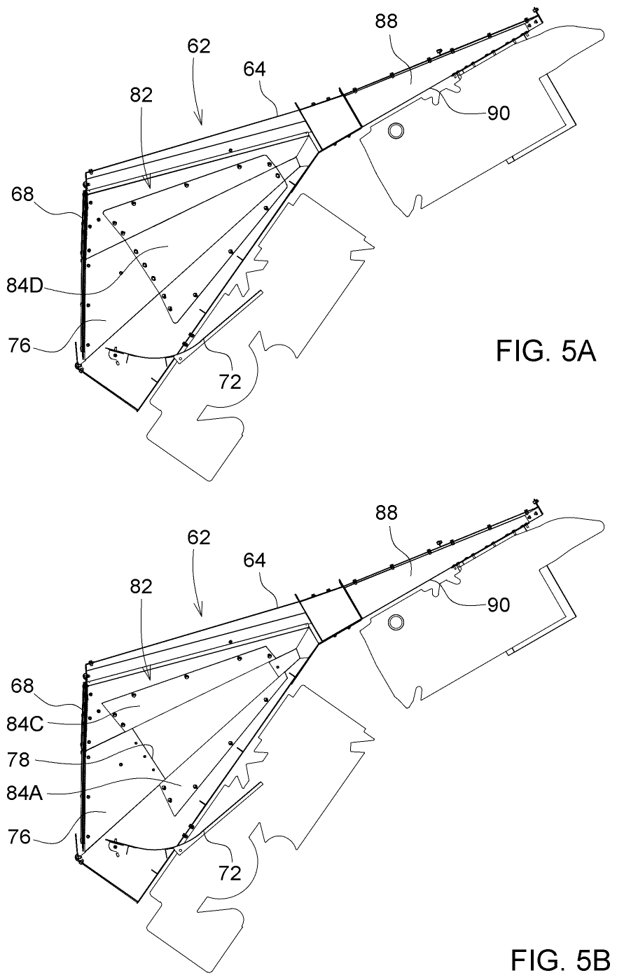

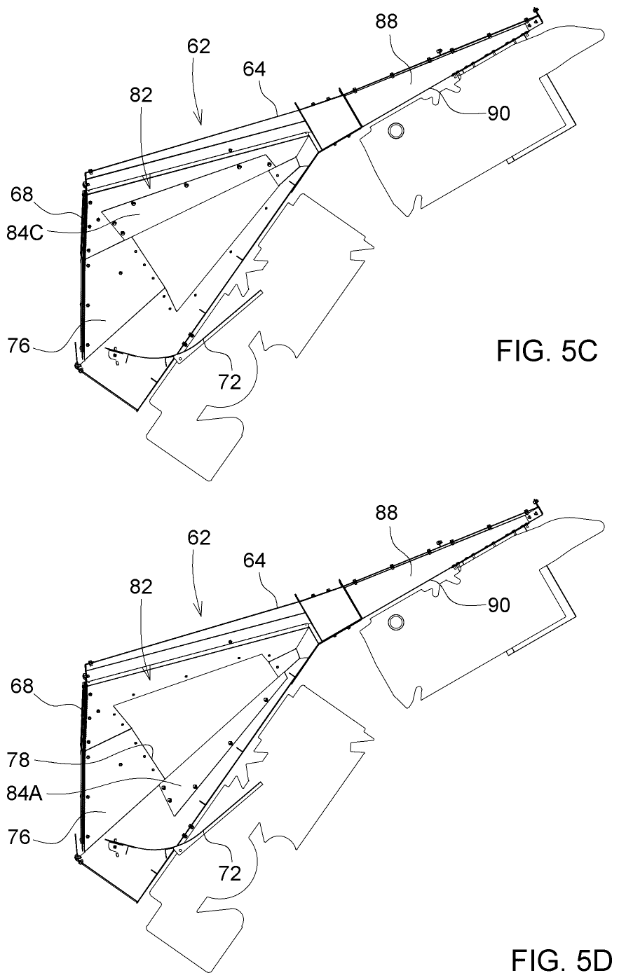

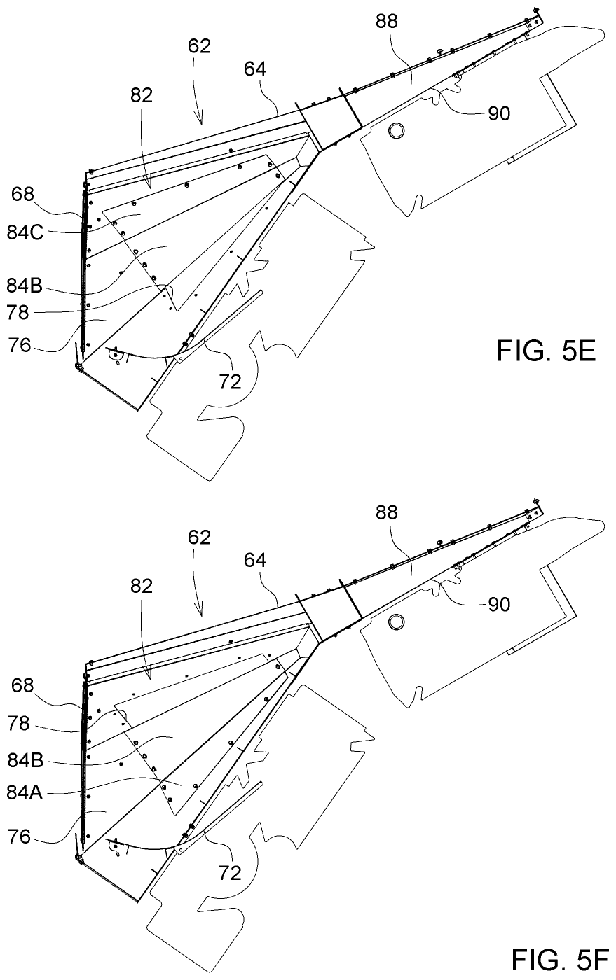

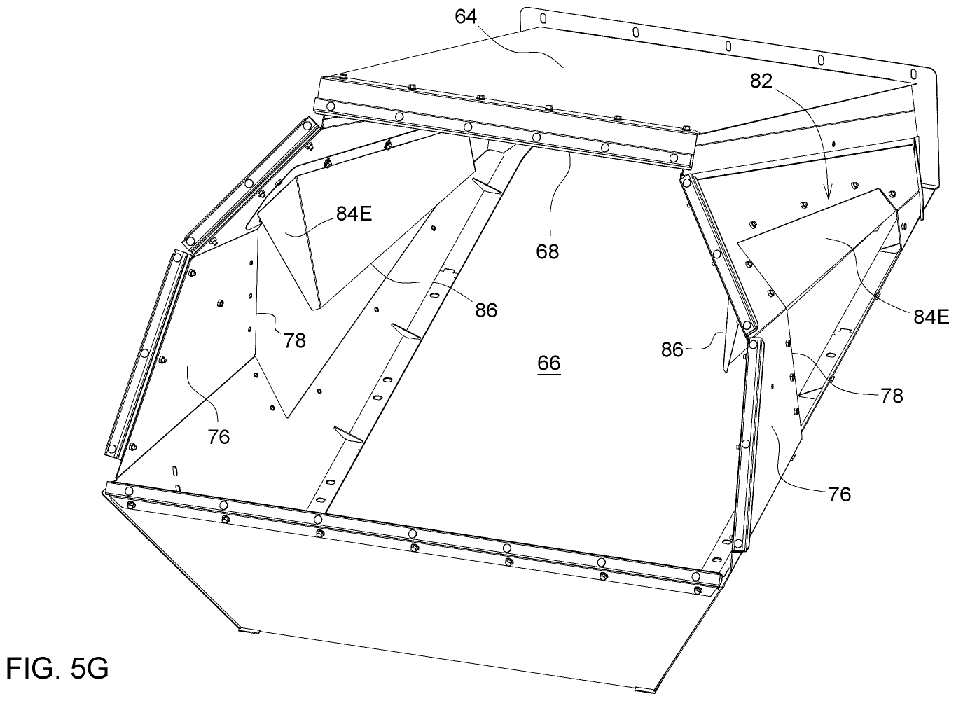

The residue capture system 62 may further include a vent cover system 82. The vent cover system 82 may include one or more panel segments 84A-84E. For example, the vent cover system 82 may include multiple panel segments 84A-84E that may be selectively configurable and/or attached to the collection housing 64 to cover at least a portion of the lower vent port 78. Referring to FIGS. 5A-5G, different panel segments 84A-84E may cover differ amounts and/or different locations of the lower vent port 78. In other implementations, one of the panel segments 84A-84E may include an adjustable opening to change the amount of the lower vent port 78 that is covered by the vent cover system 82. It should be appreciated that various combinations of the panel segments 84A-84E may be selected and used to control the size, shape and portion of the lower vent port 78 that is covered and/or blocked.

As shown in FIGS. 5A-5G, the vent cover system 82 provides a degree of adjustability to control how much air, if any, is allowed to escape through the lower vent structure 74A, 74B. For example, if the vent cover system 82 is configured to completely cover and seal the lower vent port 78, then no air is allowed to escape through the lower vent structure 74A, 74B. In contrast, if the vent cover system 82 is configured to fully open the lower vent port 78, then a maximum amount of air may be allowed to pass through the lower vent structure 74A, 74B. The amount of leaf material captured by the residue capture system 62 may be adjusted by the configuration of the vent cover system 82. For example, if the vent cover system 82 is configured to fully open the lower vent port 78, then a larger amount of the leaf material may escape the residue capture system 62, thereby reducing the amount of leaf material captured by the residue capture system 62. In contrast, if the vent cover system 82 is configured to completely cover and seal the lower vent port 78, then no air leaf material may escape the residue capture system 62, thereby increasing the amount of leaf material captured by the residue capture system 62.

Referring to FIG. 5G, in one example implementation, one of the panel segments 84A-84E may include an internal baffle 86. The internal baffle 86 may extend into the collection chamber 66. The internal baffle 86 may be shaped and/or configured to help direct air movement through the lower vent port 78, and/or control movement of the leaf material within the collection chamber 66 and/or through the lower vent port 78.

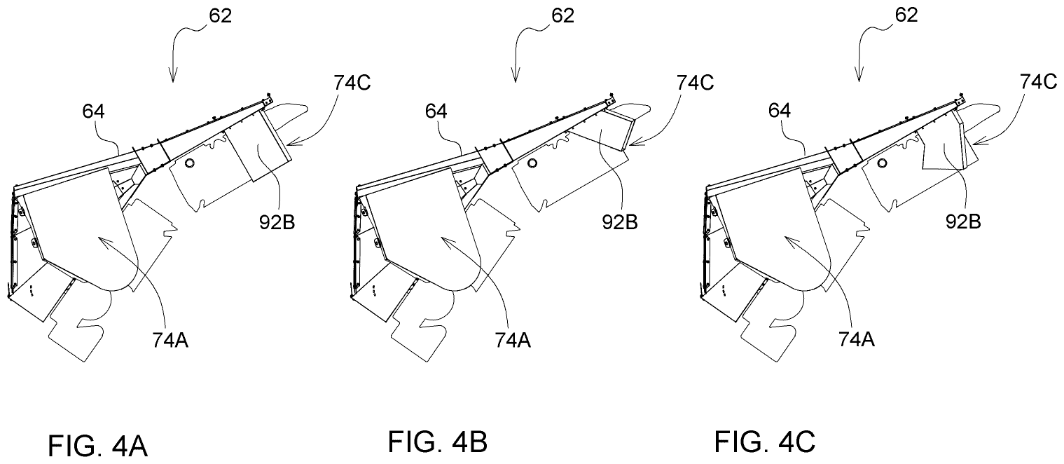

Referring to FIG. 3, the upper vent structure 74C, 74D includes an offset plenum 88 attached to the collection housing 64 for receiving air through an upper vent port 90. The offset plenum 88 includes a downspout 92A-92C. The downspout 92A-92C may be configured and/or shaped to direct air discharge in different directions. Various implementations of the downspout are shown at 92A, 92B, 92C, which may be selected based on desired air discharge characteristics. The various implementations of the downspout 92A, 92B, 92C may be interchangeable, such as shown in FIGS. 4A-4C. It should be appreciated that the shape of the downspout 92A-92C may differ from the example implementations shown in the Figures.

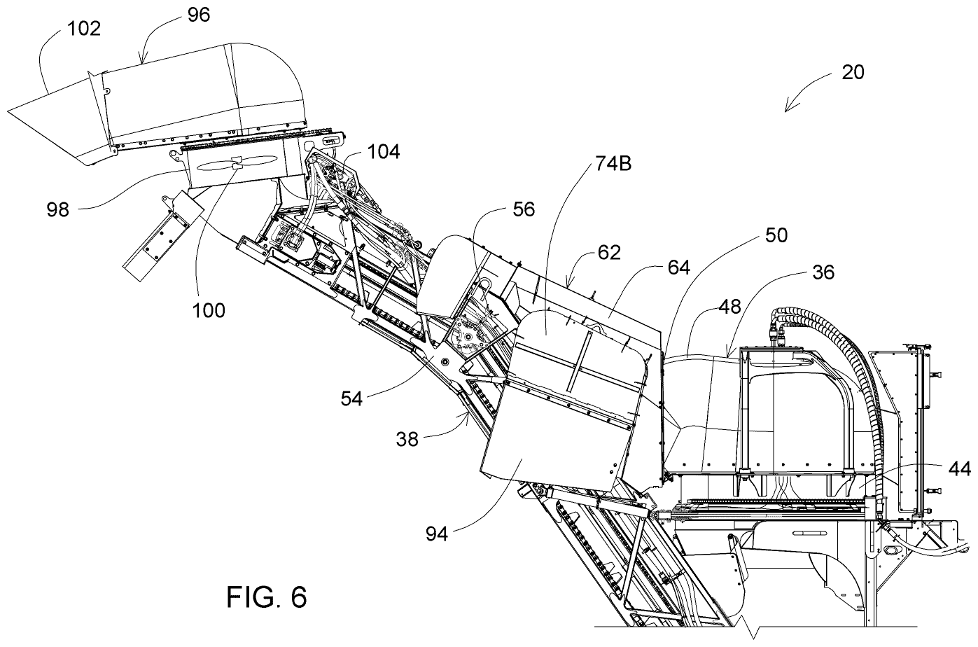

Referring to FIGS. 6-9, an alternative implementation of the sugarcane harvester 20 is shown. It should be appreciated that features disclosed throughout FIGS. 1-5 may be included in the implementation of the sugarcane harvesters 20 shown in FIGS. 6-9. Similarly, it should be appreciated that features disclosed throughout FIGS. 6-9 may be included in the implementation of the sugarcane harvester 20 shown in FIGS. 1-5.

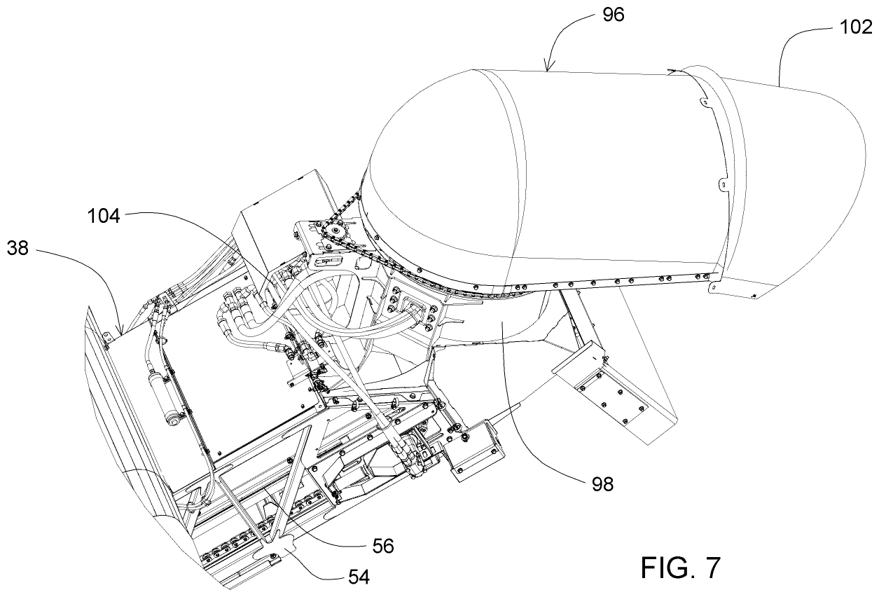

Referring to FIGS. 6 and 7, the sugarcane harvester 20 may optionally be equipped with a secondary extractor 96. The secondary extractor 96 is coupled to the elevator structure 54 proximate the distal discharge end of the elevator structure 54. The secondary extractor operates in a similar manner as the primary extractor 36. Particularly, the secondary extractor may include a fan housing 98 defining an interior passage extending along a central axis. The secondary extractor 96 further includes a fan assembly 100 disposed and/or positioned within the interior passage of the fan housing 98. The fan assembly 100 includes one or more fan blades (e.g., four fan blades) mounted for rotation about the central axis in a direction of rotation of the fan blades. Rotation of the fan blades about the central axis induces a flow of air through the interior passage of the fan housing 98 of the secondary extractor 96. The flow of air through the fan housing 98 extracts the leaf material from the flow of the combination of the billets and the leaf material discharged from the top of the conveyor 56. A hood 102 is attached to the fan housing 98 of the secondary extractor 96. The hood 102 defines an exhaust outlet through which the leaf material is discharged from the secondary extractor 96.

The secondary extractor 96 may further include a speed controller 104 operable to control a speed of the fan assembly 100. In one implementation, the speed controller 104 may include, but is not limited to, a variable hydraulic control valve. The speed controller may be controlled by an operator and/or by an automated machine controller to vary the speed of the fan assembly 100. By varying the speed of the fan assembly 100, the speed and/or volume of air moved through the flow of the combination of the billets and the leaf material discharged from the conveyor 56 may be varied or changed. This in turn controls how much of the leaf material may be extracted from the flow of the combination of the billets and the leaf material discharged from the conveyor.

The amount of leaf material captured by the residue capture system 62 may be adjusted by the speed of the fan assembly 100 of the secondary extractor 96. For example, if the speed controller 104 commands the fan assembly 100 to operate at a higher speed, thereby moving more air through the flow of discharged material, then a larger amount of the leaf material may be extracted by the secondary extractor 96, thereby reducing the amount of leaf material captured by the residue capture system 62. In contrast, if the speed controller 104 commands the fan assembly 100 to operate at a lower speed, thereby moving less air through the flow of discharged material, then a smaller amount of the leaf material may be extracted by the secondary extractor 96, thereby increasing the amount of leaf material captured by the residue capture system 62.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

What is claimed is:

1. A sugarcane harvester comprising:
a main frame
a basecutter assembly having a cutting disk configured for severing stalks of sugarcane adjacent a ground surface;
a chopper having a drum configured for cutting the stalks of sugarcane into billets;
an extractor having a fan assembly configured to induce a flow of air through the billets for separating leaf material from the billets;
wherein the extractor includes a hood moveable relative to the main frame, wherein the hood includes an exhaust outlet that is selectively positionable relative to the main frame for discharging the leaf material from the extractor in a desired direction;
an elevator including an elevator structure attached to the main frame and extending to a distal discharge end, wherein the elevator includes a conveyor moveably supported on the elevator structure and operable to receive the billets from the chopper and lift the billets to the distal discharge end of the elevator structure; and
a residue capture system attached to the elevator structure and configured for receiving the leaf material discharged from the extractor, whereby the leaf material settles onto the conveyor of the elevator.

2. The sugarcane harvester set forth in claim 1, wherein the residue capture system includes a collection housing defining a collection chamber having an inlet arranged for receiving the leaf material from the exhaust outlet of the hood.

3. The sugarcane harvester set forth in claim 2, wherein the inlet of the collection housing of the residue capture system includes a shape configured to substantially mate with a shape of the exhaust outlet of the hood.

4. The sugarcane harvester set forth in claim 2, wherein the residue capture system includes a seal disposed between the collection housing of the residue capture system and the hood for sealing therebetween.

5. The sugarcane harvester set forth in claim 4, wherein the seal is attached to the collection housing of the residue capture system.

6. The sugarcane harvester set forth in claim 4, wherein the seal is attached to the extractor.

7. The sugarcane harvester set forth in claim 2, wherein the collection housing of the residue capture system includes a deflector disposed within the collection chamber for directing movement of the leaf material through the collection chamber.

8. The sugarcane harvester set forth in claim 2, wherein the residue capture system includes a vent structure coupled to the collection housing and configured to vent air pressure from within the collection chamber.

9. The sugarcane harvester set forth in claim 8, wherein the vent structure is configured to discharge leaf material from the collection housing to control an amount of leaf material collected.

10. The sugarcane harvester set forth in claim 8, wherein the collection housing of the residue capture system includes a side wall extending vertically along a lateral side of the conveyor, wherein the side wall defines a vent port positioned above the conveyor.

11. The sugarcane harvester set forth in claim 10, wherein the vent structure is attached to an exterior of the collection housing to cover the vent port.

12. The sugarcane harvester set forth in claim 11, wherein the vent structure cooperates with the side wall to define an opening positioned below the conveyor.

13. The sugarcane harvester set forth in claim 12, further comprising a flexible panel disposed adjacent a bottom edge of the vent structure and extending at least partially about the opening.

14. The sugarcane harvester set forth in claim 10, further comprising a vent cover system having a panel selectively configurable to cover at least a portion of the vent port.

15. The sugarcane harvester set forth in claim 14, wherein the panel includes a plurality of panel segments.

16. The sugarcane harvester set forth in claim 14, wherein the panel includes an internal baffle extending into the collection chamber.

17. The sugarcane harvester set forth in claim 1, wherein the extractor includes a leaf shredder configured for shredding the leaf material passing through the extractor.

18. The sugarcane harvester set forth in claim 1, further comprising a secondary extractor attached to the distal discharge end of the elevator structure and configured to induce a flow of air through the combined flow of billets and leaf material discharged from the conveyor for removing a portion of the leaf material from the billets.

19. The sugarcane harvester set forth in claim 18, further comprising a speed controller coupled to the secondary extractor and selectively controllable to control a fan speed of the secondary extractor.

20. The sugarcane harvester set forth in claim 19, wherein the speed controller includes a variable hydraulic control valve.
